(19) United States
(12) Patent Application Publication
(10) Pub. No.: US 2026/0300584 A1
(43) Pub. Date: Oct. 1, 2026

(54) METHODS AND SYSTEMS FOR THERMAL MIX-POINT FATIGUE ANALYSIS

(71) Applicant: Akselos S.A, Lausanne (CH)

(72) Inventors: David Knezevic, Brookline, MA (US); Alexis Picard, Lausanne (CH); Stefan Irrgang, Rohrbach (DE); Wesley Pudwill, Tabernash, CO (US)

(21) Appl. No.: 19/093,504

(22) Filed: Mar. 28, 2025

(51) Int. Cl. G06F 30/28

(52) U.S. Cl. CPC G06F 30/28; G21C 17/017

(57) ABSTRACT

A method for maintaining at least one physical asset based on recommendations generated by analyzing at least one model of the at least one physical asset includes constructing, by a computing device, at least one model representing at least one region of a physical asset, the physical asset comprising at least one thermal mix-point (TMP). The computing device executes a computational fluid dynamics (CFD) analysis of at least one property of the at least one TMP. The computing device generates a time series of an output of the CFD analysis. The computing device executes, for at least one time step in the generated time series, a structural analysis process of the physical asset. The computing device executes a fatigue analysis of at least one region of the physical asset and generates an assessment of a level of fatigue of the at least one region.

### BACKGROUND

The traditional approach to management of industrial machinery and infrastructure from the point of view of structural integrity is to perform extensive analysis at design time to attempt to assess all relevant operational conditions and based on this analysis to decide on (i) the asset's operational lifetime, and (ii) a prescriptive scheme (often based on fixed time intervals) for inspection, maintenance, and repair. A key observation in this work is that this design-based prescriptive methodology is fundamentally limited by the large amount of uncertainty about what the true operating conditions of the asset will be. Since, of course, future operating conditions are unknown at design time, the only option is to make conservative assumptions and build in large safety factors to compensate for uncertainty. In practice, when this type of design-time analysis is fully relied upon, this leads to over-design of assets (with corresponding excessive capital expenditure), or premature decommissioning compared to the true capacity of a structure or both. Moreover, even with conservative design assumptions, there is an ever-present risk of unforeseen circumstances during operations that go beyond the “worst case” assumed during design, such as extreme weather, or accidents.

Mix-points are pipe junctions in which fluids mix. A typical mix-point would be a T-junction, and would have incoming fluids with different temperatures, flow rates, phases (gas/liquid) etc. Thermal mix-points (TMPs) are critical for operation of petrochemical plants; for example, one major operator has 25,000 such mix-points in their global operations. TMPs are susceptible to structural integrity failures due to structural fatigue. Fatigue is driven by cyclic loading (e.g. temperature and/or pressure variations) due to the mixing fluids. This can lead to cracks developing in the TMPs and, hence, can be a source of unplanned downtime for petrochemical operators, leading to large costs.

Therefore, there is a need for solutions that provide modeling of conditions and recommendations for maintenance and safety throughout a physical asset's operational lifetime and that provide functionality for assessing in particular the damage that can be expected to develop due to fatigue.

### BRIEF SUMMARY

In one aspect, a method for maintaining at least one physical asset based on fatigue analysis outputs generated by analyzing at least one model of the at least one physical asset, includes constructing, by a computing device, at least one model representing at least one region of a physical asset, the physical asset comprising at least one thermal mix-point (TMP). The method includes executing, by the computing device, a computational fluid dynamics (CFD) analysis of at least one property of the at least one TMP, wherein executing the CFD analysis includes executing a turbulence modeling analysis and a heat transfer analysis, using the at least one model. The method includes generating, by the computing device, a time series of an output of the CFD analysis. The method includes executing, by the computing device, for at least one time step in the generated time series a structural analysis process of the physical asset using the output of the CFD analysis. The method includes executing, by the computing device, a fatigue analysis of at least one region of the physical asset based on the time series and the structural analysis process. The method includes generating, by the computing device, an assessment of a level of fatigue of the at least one region based upon an output of the fatigue analysis.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram depicting an embodiment of a system for maintaining at least one physical asset based on fatigue analysis outputs generated by analyzing at least one model of the at least one physical asset, the at least one model representing at least one of a plurality of components of the at least one physical asset;

FIG. 2 is a flow diagram depicting one embodiment of a method for maintaining at least one physical asset based on fatigue analysis outputs generated by analyzing at least one model of the at least one physical asset, the at least one model representing at least one of a plurality of components of the at least one physical asset; and

FIGS. 3A-3C are block diagrams depicting embodiments of computers useful in connection with the methods and systems described herein.

### DETAILED DESCRIPTION

The methods and systems described herein may provide functionality for performing structural integrity monitoring and reassessment during operation.

The methods and systems described herein provide functionality for maintaining at least one physical asset based on fatigue analysis outputs generated by analyzing at least one model of the at least one physical asset, the at least one model representing at least one of a plurality of components of the at least one physical asset. By way of example, the TMP may be a physical component in or associated with a physical asset and the methods and systems described herein may analyze at least one model representing at least one TMP. The methods and systems herein may provide functionality for analyzing TMPs and for assessing a level of fatigue damage that can be expected to develop based on factors such as fluid properties, flow rates, TMP geometry, pipe material properties, etc. and hence to generate and provide an assessment of the failure risk of each TMP. Operators may use such assessments to determine which TMPs across one or more physical assets are highest risk, and which ones to prioritize for inspection or structural integrity interventions, such as introduction of a “thermal sleeve” or an “injection quill.”

Using the methods and systems described herein provides a powerful approach for enabling modeling of TMPs within large-scale systems. These capabilities are further realized by connecting the models generated as described herein to inspection and sensor data and configuring post-processing for the purposes of automated asset integrity reporting.

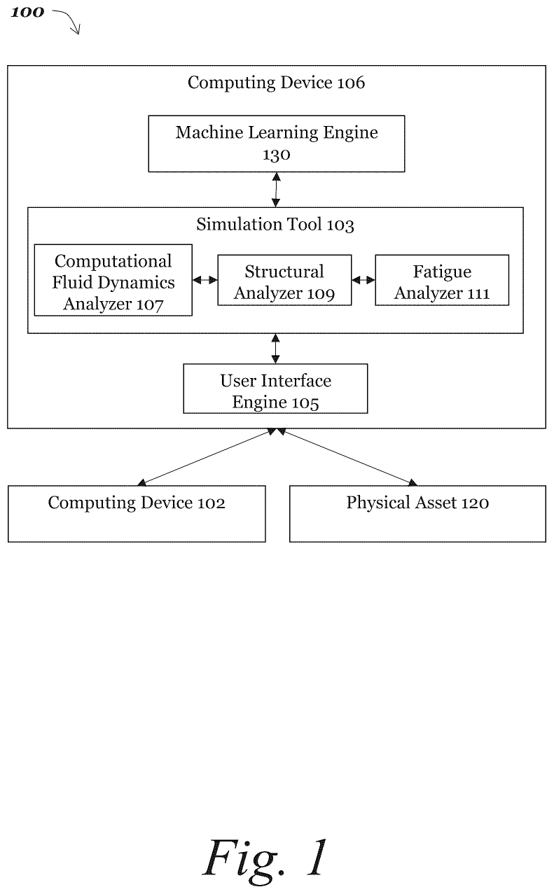

Referring now to FIG. 1, a block diagram depicts a system 100 for maintaining at least one physical asset based on fatigue analysis outputs generated by analyzing at least one model of the at least one physical asset, the at least one model representing at least one of a plurality of components of the at least one physical asset. The system 100 includes a computing device 102, a computing device 106, and a physical asset 120. The system 100 includes a simulation tool 103, a CFD analyzer 107, a structural analyzer 109, a fatigue analyzer 111, a user interface engine 105, and a machine learning engine 130.

The simulation tool 103 may execute or be in communication with the CFD analyzer 107. The simulation tool 103 may execute or be in communication with the structural analyzer 109. The simulation tool 103 may execute or be in communication with the fatigue analyzer 111. The simulation tool 103 may execute or be in communication with the user interface engine 105. The simulation tool 103 may be in communication with the machine learning engine 130.

The user interface engine 105 may be implemented as a browser-based tool. The user interface engine 105 may generate a user interface for display to a user of a computing device 102; for example, within an internet browser application executed by the computing device 102. The user interface generated by the user interface engine 105 may include at least one user interface element for receiving a parameter. The user interface generated by the user interface engine 105 may include at least one user interface element for requesting execution of the method 200 described below.

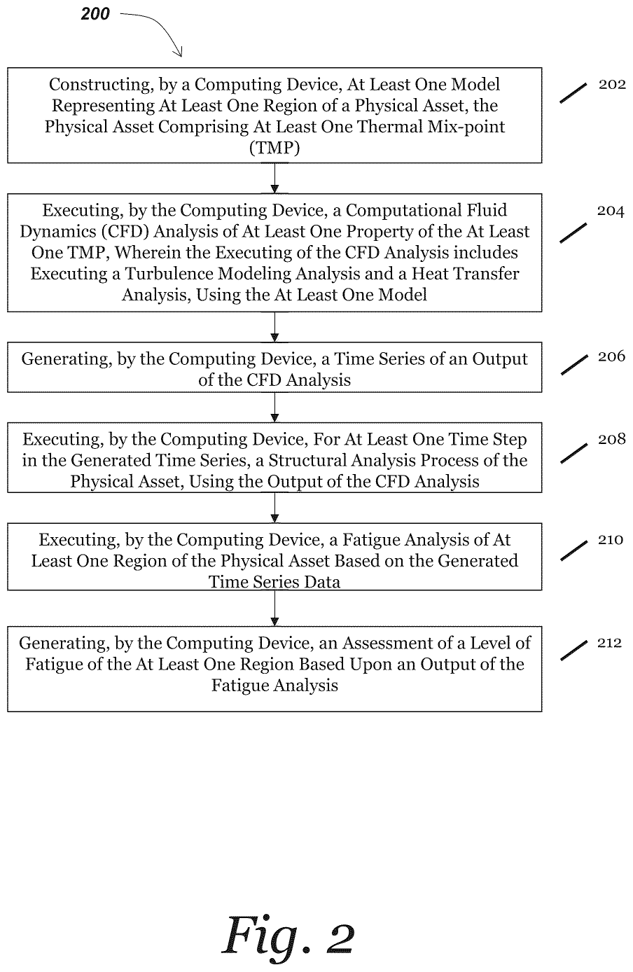

Referring now to FIG. 2, in conjunction with FIG. 1, in brief overview, a flow diagram depicts one embodiment of a method 200 for maintaining at least one physical asset based on fatigue analysis outputs generated by analyzing at least one model of the at least one physical asset, the at least one model representing at least one of a plurality of components of the at least one physical asset. The method 200 includes constructing, by a computing device, at least one model representing at least one region of a physical asset, the physical asset comprising at least one TMP (202). The method 200 includes executing, by the computing device, a CFD analysis of at least one property of the at least one TMP, wherein the executing of the CFD analysis includes executing a turbulence modeling analysis and a heat transfer analysis, using the at least one model (204). The method 200 includes generating, by the computing device, a time series of an output of the CFD analysis (206). The method 200 includes executing, by the computing device, for at least one time step in the generated time series, a structural analysis process of the physical asset using the output of the CFD analysis (208). The method 200 includes executing, by the computing device, a fatigue analysis of at least one region of the physical asset based on the time series and the structural analysis process (210). The method 200 includes generating, by the computing device, an assessment of a level of fatigue of the at least one region based upon an output of the fatigue analysis (212).

In some embodiments, the simulation tool 103 receives one or more parameters (such as geometrical, flow, and/or material parameters) that characterize one or more TMPs, maps the temperature profile from a CFD into a structural model, performs a structural analysis to obtain a stress time series, performs a fatigue analysis given the stress time series, and generates an identification of a level of fatigue at the TMP.

Referring now to FIG. 2, in conjunction with FIG. 1, and in greater detail, the method 200 includes constructing, by a computing device, at least one model representing at least one region of a physical asset, the physical asset comprising at least one TMP (202). The simulation tool 103 may construct the at least one model representing the at least one region of the physical asset 120. The simulation tool 103 may execute one or more methods to construct one or more parts of the at least one model. By way of example and without limitation, the simulation tool 103 may execute a full-order model. The simulation tool 103 may construct the at least one model using a Finite Element (FE) method. The simulation tool 103 may construct the at least one model using a Computational Fluid Dynamics (CFD) method. Both the FE and CFD approaches may be referred to as full order methods. The simulation tool 103 may construct the at least one model using a machine learning engine trained to evaluate specific quantities of interest as a function of parameters and provides fast parametric modeling. As another example and without limitation, the simulation tool 103 may execute a reduced-order model. The simulation tool 103 may construct the at least one model using a reduced order modeling (ROM) method, which may include Parabolic Orthogonal Decomposition (POD), Proper Generalized Decomposition (PGD), or Certified Reduced Basis Method. The simulation tool 103 may construct the at least one model using a Reduced Basis Element (RBE), which may include both or either linear or non-linear versions of RBE. The simulation tool 103 may construct the at least one model using a component-based ROM approach based on the Static Condensation Reduced Basis Element (SCRBE) framework, in which the SCRBE methodology builds on the Certified Reduced Basis Method to provide a physics-based ROM of parametric partial differential equations (PDEs).

The method 200 includes executing, by the computing device, a CFD analysis of at least one property of the at least one TMP, wherein the executing of the CFD analysis includes executing a turbulence modeling analysis and a heat transfer analysis, using the at least one model (204). The simulation tool 103 may execute the CFD analyzer 107. The simulation tool 103 may execute the CFD analyzer 107 based on the TMP properties such as, without limitation, geometry, material properties, flow rates, and temperatures. The simulation tool 103 may execute the CFD analyzer 107 to execute the turbulence modeling analysis. The simulation tool 103 may execute the CFD analyzer 107 to execute the heat transfer analysis. The heat transfer analysis may be a conjugate heat transfer analysis. The heat transfer CFD analysis may be performed with an automated CFD mesh representing both the solid pipe of the TMP and the internal flow of liquid through the TMP, allowing the capture of the temperature variation through the pipe thickness. The CFD analyzer 107 may execute a steady solve to initialize the transient solve accelerating flow development and reduce computational costs. The CFD analyzer 107 may extract time-dependent, three-dimensional temperature field of the pipe, in a format for processing by a visual toolkit, over a period of time (such as, without limitation a period of time substantially similar to one hundred seconds). The simulation tool 103 may model the temperature in the fluid and the pipe by executing these analyses. In embodiments in which the simulation tool 103 receives data from a sensor associated with the physical asset or from an operating point associated with the physical asset, the simulation tool 103 may incorporate the received data into the CFD analysis. As an example, and without limitation, the simulation tool 103 may incorporate into the analysis data representing factors such as fluid temperatures or flow rates at inlets to a TMP; the CFD analyzer 107 may simulate the fluid flow and/or fluid mixing in the TMP based on the received data.

The method 200 includes generating, by the computing device, a time series of an output of the CFD analysis (206). The CFD analyzer 107 may generate a time series of temperature and pressure data in a fluid and in a pipe of the TMP. A time series, as will be understood by those of skill in the art, may be a series of data points arranged in time order (e.g., indexed, listed, or graphed) and may be a sequence of discrete-time data taken at successive points in time over a period of time.

The method 200 includes executing, by the computing device, for at least one time step in the generated time series, a structural analysis process of the physical asset using the output of the CFD analysis (208). The structural analyzer 109 may generate a stress time series representing conditions (including temperature and pressure) in a TMP pipe over time.

The simulation tool 103 may perform a Finite Element Analysis (FEA) to evaluate a level of thermal expansion caused by a level of temperature variation inside a pipe of the TMP. The simulation tool 103 may map the CFD results onto an automated mesh to perform the FEA. The simulation tool 103 may extract data associated with a stress history for at least one point in the mesh.

The method 200 includes executing, by the computing device, a fatigue analysis of at least one region of the physical asset based on the time series and the structural analysis process (210). The fatigue analyzer 111 may perform a fatigue analysis based on the time series data at each TMP. The fatigue analyzer 111 may produce a fatigue damage prediction throughout the TMP pipe. The fatigue analyzer 111 may produce a fatigue damage analysis for every point of an FEA mesh. The fatigue analyzer 111 may produce a fatigue damage analysis for a subset of points of an FEA mesh. The fatigue analyzer 111 may product an output that contours accumulated fatigue damage. The fatigue analyzer 111 may product an output that contours maximum fatigue damage.

The method 200 includes generating, by the computing device, an assessment of a level of fatigue of the at least one region based upon an output of the fatigue analysis (212). The simulation tool 103 may generate the assessment of the level of fatigue based on the fatigue damage prediction. The simulation tool 103 may identify locations that have fatigue damage about a pre-specified threshold; the simulation tool 103 may then classify the fatigue level throughout the TMP based on the fatigue damage predictions.

In some embodiments, the method 200 includes repeating the execution of the method 200 for one or more additional regions (or components) of the second physical asset. Therefore, the method 200 may include constructing, by the computing device, at least a second model representing at least one region of a second physical asset, the second physical asset comprising at least a second thermal mix-point (TMP); executing, by the computing device, a computational fluid dynamics (CFD) analysis of at least one property of the at least the second TMP; generating, by the computing device, a second time series of a second output of the second CFD analysis; executing, by the computing device, for at least one time step in the generated second time series, a second structural analysis process of the second physical asset; executing, by the computing device, a second fatigue analysis of the at least one region of the second physical asset based on the second time series; generating, by the computing device, a second assessment of a level of fatigue of the at least the second region based upon an output of the second fatigue analysis; and displaying, by the computing device, the generated second assessment.

The method 200 may include execute steps (204)-(212) for an operating point of the TMP, where the operating point refers to all of the parameters (flow rates, temperatures, etc.) that determine a current state of the TMP. For example, the operating point may be an operating point specified in a plan design associated with the physical asset 120. As another example, the operating point may be based on a “current” operating point (which may deviate from the design operating point), as measured by one or more sensors associated with the physical asset 120. Therefore, the system 100 may receive data associated with the operating point associated with the physical asset and generate an original or updated assessment of the level of fatigue of the at least one region of the physical asset 120 using the received data associated with the operating point.

The method 200 may include modifying a user interface to include a display of the assessment of the generated level of fatigue. The method 200 may include generating a recommendation for maintaining the physical asset 120 based upon the generated assessment. The method 200 may include displaying, by the computing device 106, a generated recommendation for maintaining the physical asset based upon the generated assessment. By way of example, the simulation tool 103 may modify a user interface element in a user interface displayed by the user interface engine 105 to include at least one of the generated recommendation and the generated assessment.

The method 200 may include receiving, by the computing device 106, from a first operational data source associated with the physical asset 120, first operational data associated with at least one region of the physical asset 120. The computing device 106 may receive from the first operational data source associated with the physical asset 120, the first operational data generated by a sensor associated with the physical asset 120. The computing device 106 may receive from the first operational data source associated with the physical asset 120 first operational data extracted from an inspection report associated with the physical asset 120; for example, the inspection data may include a result from a visual inspection of the physical asset 120. The computing device 106 may receive from the first operational data source associated with the physical asset 120, first operational data extracted from a report generated by an operator of the physical asset 120. The operational data inputs to a digital thread may include the inspection and sensor data available from operational physical assets 120. Examples include, without limitation, thickness measurements based on ultrasound thickness gauging; environmental monitoring at specific intervals in time, e.g. wind and wave states for an offshore structure; operational load monitoring, e.g. throughput rates, tank fill levels, and number of loading/unloading cycles per time interval; measurements from structural sensors such as accelerometers and strain gauges; pressure and/or temperature monitoring. In some embodiments, therefore, the system 100 may receive data from a sensor associated with the physical asset; re-execute steps (204-210); and generate an updated assessment of the level of fatigue of the at least one region. In some embodiments in which the simulation tool 103 generated a visual rendering of the model, the simulation tool 103 may update the visual rendering of the model based on updated output values generated by the model using the received first operational data. In some embodiments, the system 100 may receive data from an operating point associated with the physical asset; re-execute steps (204-210); and generate an updated assessment of the level of fatigue of the at least one region.

The method 200 may include training, by the computing device 106, the machine learning engine 130, using the input to the CFD analysis and the output of the fatigue analysis and the generated assessment of the level of fatigue. The computing device 106 may train the machine learning engine 130 to learn an input/output mapping using a database of TMP analysis results that map from a TMP operating point to a level of fatigue. The machine learning engine 130 may develop an increased level of reliability as a predictor of TMP fatigue damage as the database of results increases. The machine learning engine 130 may provide a useful complement to the full-fidelity analysis described above as it may be used to assess a new TMP in seconds (whereas a full-fidelity analysis may take more than 24 hours to run) and hence the machine learning engine 130 may provide functionality for screening TMPs in a shorter time frame. The machine learning engine 130 may also be executed to identify a subset of TMPs throughout one or more physical assets 120 for prioritized full-fidelity analysis.

Subsequent to the training, the computing device 106 may receive updated data from a sensor associated with the physical asset and direct the machine learning engine to execute (or re-execute) steps (204-210). The machine learning engine 130 may then generate an updated assessment of the level of fatigue of the at least one region. The computing device 106 may modify a display of the recommendation based upon the generated updated assessment.

Alternatively, or additionally, the computing device may receive updated data associated with an operating point associated with the physical asset and direct the machine learning engine to execute (or re-execute) steps (204-210). The machine learning engine 130 may then generate an updated assessment of the level of fatigue of the at least one region based upon the data associated with the operating point. The computing device 106 may modify a display of a user interface to include the generated updated assessment.

In some embodiments, the method 200 includes constructing, by the computing device 106, at least a second model representing at least one region of a second physical asset 120b (not shown), the second physical asset 120b comprising at least a second thermal mix-point (TMP). The method 200 may include executing, by the machine learning engine 130, a computational fluid dynamics (CFD) analysis of at least one property of the at least the second TMP. The method 200 may include generating, by the machine learning engine, a second time series of a second output of the second CFD analysis. The method 200 may include executing, by the machine learning engine, for at least one time step in the generated second time series, a second structural analysis process of the second physical asset. The method 200 may include executing, by the machine learning engine, a second fatigue analysis of the at least one region of the second physical asset based on the second time series data. The method 200 may include generating, by the machine learning engine, a second assessment of a level of fatigue of the at least the second region based upon an output of the second fatigue analysis. The method 200 may include displaying, by the computing device, a the generated second assessment.

In some embodiment, each execution of the steps (204)-(210) includes mapping from input parameters (including, without limitation, flow parameters and geometry parameters) to fatigue. As one example of an implementation leveraging machine learning, the generated data points can be interpolated via a response surface, which may provide substantially instantaneous results, which may be used for screening TMPs and/or for prioritizing an order in which to execute a full analysis of one or more TMPs.

In some embodiments, the method 200 may include generating, by a simulation tool 103 executed by the computing device 106, a visual rendering of the model including a visualization of at least one result of a physics-based analysis of the physical asset 120. The simulation tool 103 may generate a visual rendering of the entire model, including visualizations of all results of the physics-based analyses of the physical assset. Alternatively, the simulation tool 103 may visualization a subset of the resulting values; for example, the simulation tool 103 may visualzation a level of fatigue at a single TMP, as opposed to a level of fatigue at each TMP throughout the physical asset 120. The simulation tool 103 may include or be in communication with a user interface generated by the user interface engine 105 with which a user of the system 100 may interact with the visual rendering of the composite model and provide user input. For instance, the user interface engine 105 may generate a user interface allowing the user to construct a model for a physical system by specifying one or more aspects of the physical system, such as geometry, material, and/or any other suitable physical characteristics. Once such a model is constructed, the user may, again via the user interface generated by the user interface engine 105, direct the simulation tool 103 to perform a simulation based on the model to predict how the physical system may behave under one or more selected conditions. Results of the simulation may be delivered to the user via the user interface generated by the user interface engine 105 in any suitable manner, such as by visually rendering one or more output values of the simulation. Therefore, an improved simulation tool is provided that allows a user to modify one or more aspects of a physical system and obtain updated simulation results in real time.

The methods and systems described herein enable an automated framework that provides operators with deeper structural integrity insights based on the “as is” state of critical assets and hence empowers safer and more efficient operations. In contrast to conventional qualitative approaches, the methods and systems described herein provide a fully quantitative approach, making a quantitative fatigue prediction based on principles of physics. A key enabler for this quantitative analysis is the execution of the stress analysis of the pipe and computing the fatigue damage from the stress time series, which is not done as part of conventional methods which does not typically include a stress analysis. As a result, the methods and systems described herein may generate predictions of fatigue damage with increased levels of reliability and may provide increased levels of precision in ranking levels of fatigue associated with a plurality of TMPs.

Furthermore, the methods and systems described herein leverage execution of a machine learning engine 130, which is not implemented in conventional fatigue analysis approaches. Nor do conventional approaches provide automated analyses of TMPs and new TMP operating points, including operating points that are measured in the field.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

Although terms such as “optimize” and “optimal” may be used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs but also processes which produce outputs that approximate an optimal solution, within some degree of error.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIG. 2.

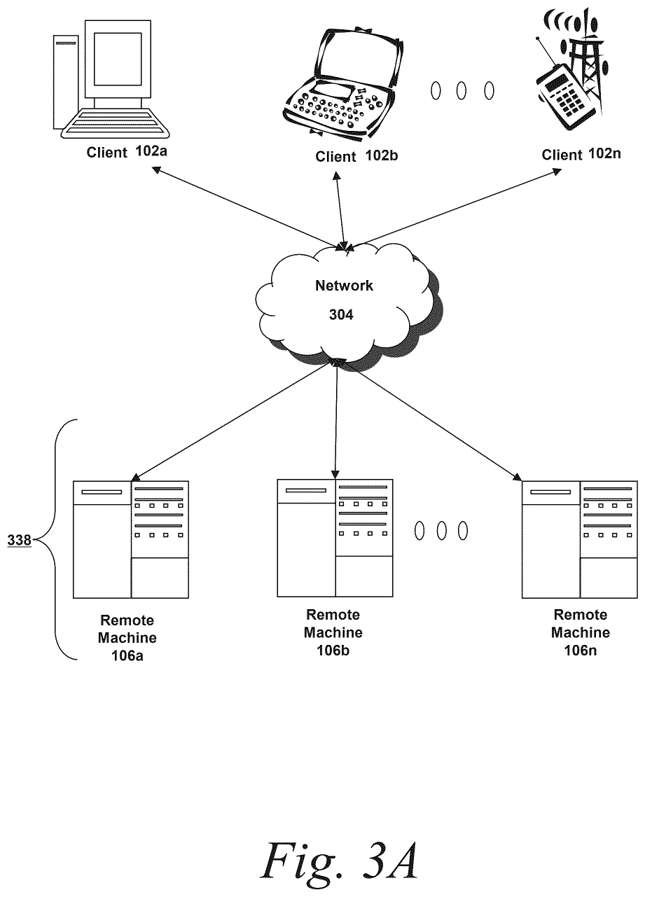

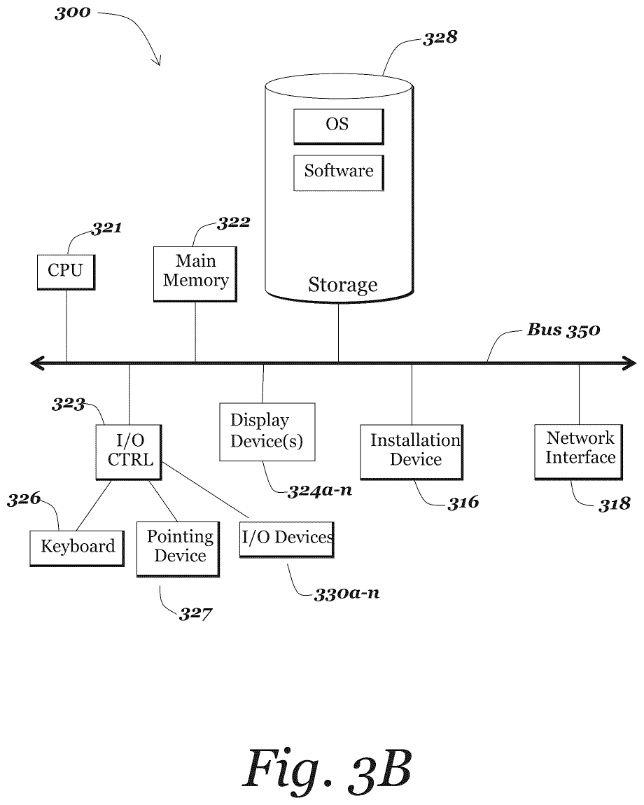

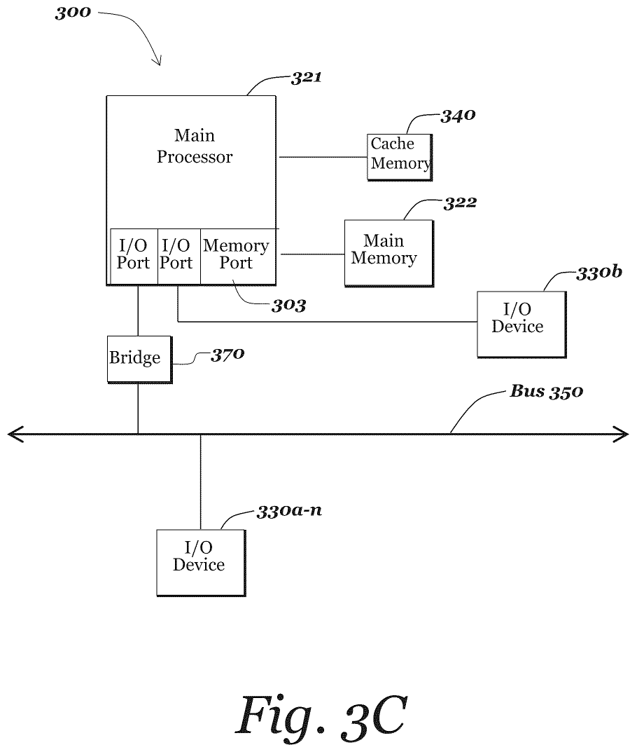

Referring now to FIGS. 3A, 3B, and 3C, block diagrams depict additional detail regarding computing devices that may be modified to execute novel, non-obvious functionality for implementing the methods and systems described above. Referring now to FIG. 3A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 304.

Although FIG. 3A shows a network 304 between the client(s) 102 and the remote machines 106, the client(s) 102 and the remote machines 106 may be on the same network 304. The network 304 can be a local area network (LAN), such as a company Intranet, a metropolitan area network (MAN), or a wide area network (WAN), such as the Internet or the World Wide Web. In some embodiments, there are multiple networks 304 between the client(s) 102 and the remote machine(s) 106. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 304 may comprise a wireless link, such as an infrared channel or satellite band. The topology of the network 304 may be a bus, star, or ring network topology. The network 304 may be of any such network topology as known to those ordinarily skilled in the art capable of supporting the operations described herein. The network 304 may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client(s) 102 and a remote machine 106 (referred to generally as computing devices 300) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client(s) 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client(s) 102.

In one embodiment, a computing device 106 provides functionality of a web server. In some embodiments, a web server 106 comprises an open-source web server, such as the NGINX web servers provided by NGINX, Inc., of San Francisco, CA, or the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the BEA WEBLOGIC products provided by BEA Systems of Santa Clara, CA.

In some embodiments, the system may include multiple, logically-grouped remote machines 106. In one of these embodiments, the logical group of remote machines may be referred to as a server farm 338. In another of these embodiments, the server farm 338 may be administered as a single entity.

FIGS. 3B and 3C depict block diagrams of a computing device 300 useful for practicing an embodiment of the client(s) 102 or a remote machine 106. As shown in FIGS. 3B and 3C, each computing device 300 includes a central processing unit 321, and a main memory unit 322. As shown in FIG. 3B, a computing device 300 may include a storage device 328, an installation device 316, a network interface 318, an I/O controller 323, display devices 324a-n, a keyboard 326, a pointing device 327, such as a mouse, and one or more other I/O devices 330a-n. The storage device 328 may include, without limitation, an operating system and software. As shown in FIG. 3C, each computing device 300 may also include additional optional elements, such as a memory port 303, a bridge 370, one or more input/output devices 430a-n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include SPARC processors, ARM processors, processors used to build UNIX/LINUX “white” boxes, and processors for mobile devices. The computing device 400 may be based on any of these processors, or any other processor capable of operating as described herein.

Main memory unit 322 may be one or more memory chips capable of storing data and allowing any storage location to be directly accessed by the central processing unit 321. The main memory unit 322 may be based on any available memory chips capable of operating as described herein. In the embodiment shown in FIG. 3B, the central processing unit 321 communicates with main memory unit 322 via a system bus 350. FIG. 3C depicts an embodiment of a computing device 300 in which the processor communicates directly with main memory unit 322 via a memory port 303. FIG. 3C also depicts an embodiment in which the central processing unit 321 communicates directly with cache memory 340 via a secondary bus, sometimes referred to as a backside bus. In other embodiments, the central processing unit 321 communicates with cache memory 340 using the system bus 350.

In the embodiment shown in FIG. 3B, the central processing unit 321 communicates with various I/O devices 330 via a local system bus 350. Various buses may be used to connect the central processing unit 321 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the central processing unit 321 may use an Advanced Graphics Port (AGP) to communicate with the video display 324. FIG. 3C depicts an embodiment of a computing device 300 in which the central processing unit 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 300, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device may also provide storage and/or an installation device 316 for the computing device 300. In some embodiments, the computing device 300 may provide USB connections (not shown) to receive handheld USB storage devices such as the USB Flash Drive line of devices manufactured by Twintech Industry, Inc. of Los Alamitos, CA.

Referring still to FIG. 3B, the computing device 300 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 300 may provide functionality for installing software over a network 304. The computing device 300 may further comprise a storage device, such as one or more hard disk drives or redundant arrays of independent disks, for storing an operating system and other software. Alternatively, the computing device 300 may rely on memory chips for storage instead of hard disks.

Furthermore, the computing device 300 may include a network interface 318 to interface to the network 304 through a variety of connections including, but not limited to, standard telephone lines, links for large area networks or for wide area networks (e.g., 802.11, T1, T3, 56kb, X.25, etc.), broadband connections (e.g., Integrated Services Digital Network, Frame Relay, Asynchronous Transfer Mode, Gigabit Ethernet, Ethernet-over-Synchronous Optical Network), wireless connections, or some combination of any or all of the above. Connections can be established using a variety of communication protocols (e.g., Transmission Control Protocol/Internet Protocol (TCP/IP), Ethernet, Gigabit Ethernet, Synchronous Optical Network (SONET), Optical Transport Network (OTN), Fiber Distributed Data Interface (FDDI), Institute of Electrical and Electronics Engineers (IEEE) 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 300 communicates with other computing devices 300′ via any type and/or form of gateway or tunneling protocol such as Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 300 to any type of network capable of communication and performing the operations described herein.

In further embodiments, an I/O device 330 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 300 of the sort depicted in FIGS. 3B and 3C typically operates under the control of operating systems, which control scheduling of tasks and access to system resources. The computing device 300 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.1-4.0, WINDOWS CE, WINDOWS XP, WINDOWS 7, WINDOWS 8, WINDOWS VISTA, and WINDOWS 10, all of which are manufactured by Microsoft Corporation of Redmond, WA; any version of MAC OS manufactured by Apple Inc. of Cupertino, CA; OS/2 manufactured by International Business Machines of Armonk, NY; Red Hat Enterprise Linux, a Linus-variant operating system distributed by Red Hat, Inc., of Raleigh, NC; Ubuntu, a freely-available operating system distributed by Canonical Ltd. of London, England; or any type and/or form of a Unix operating system, among others.

The computing device 300 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 300 may have different processors, operating systems, and input devices consistent with the device.

Having described certain embodiments of methods and systems for maintaining at least one physical asset based on fatigue analysis outputs generated by analyzing at least one model of the at least one physical asset, the at least one model representing at least one of a plurality of components of the at least one physical asset, it will now become apparent to one of skill in the art that other embodiments incorporating the concepts of the disclosure may be used. Therefore, the disclosure should not be limited to certain embodiments but rather should be limited only by the spirit and scope of the following claims.

1. A method for maintaining at least one physical asset based on fatigue analysis output generated by analyzing at least one model of the at least one physical asset, the method comprising:
(a) constructing, by a simulation tool executed by a computing device, at least one model representing at least one region of a physical asset, the physical asset comprising at least one thermal mix-point (TMP);
(b) executing, by the simulation tool, a computational fluid dynamics (CFD) analysis of at least one property of the at least one TMP, wherein executing the CFD analysis includes executing a turbulence modeling analysis and a heat transfer analysis, using the at least one model;
(c) generating, by a CFD analyzer executed by the computing device and in communication with the simulation tool, a time series of an output of the CFD analysis;
(d) executing, by a structural analyzer executed by the computing device and in communication with the CFD analyzer, for at least one time step in the generated time series, a structural analysis process of the physical asset, using the output of the CFD analysis;
(e) executing, by a fatigue analyzer executed by the computing device and in communication with the structural analyzer, a fatigue analysis of at least one region of the physical asset based on the time series and the structural analysis process;
(f) generating, by the computing device, an assessment of a level of fatigue of the at least one region based upon an output of the fatigue analysis;
(g) receiving, by the computing device, data from a sensor associated with the physical asset;
(h) repeating, by the computing device, (b)-(e) using the data from the sensor; and
(i) generating, by the computing device, an updated assessment of the level of fatigue of the at least one region.

2. The method of claim 1 further comprising modifying, by the computing device, a user interface to include a display of the assessment of the generated level of fatigue.

3. The method of claim 1 further comprising displaying, by the computing device, a recommendation for maintaining the physical asset based upon the generated assessment.

4. The method of claim 1 further comprising:
(g) receiving, by the computing device, data associated with an operating point associated with the physical asset; and
(h) generating, by the computing device, an updated assessment of the level of fatigue of the at least one region using the received data associated with the operating point.

5. The method of claim 4, wherein generating the updated assessment further comprises repeating, by the computing device, (b)-(e) using the data associated with the operating point.

6. (canceled)

7. The method of claim 1 further comprising:
(g) constructing, by the computing device, at least a second model representing at least one region of a second physical asset, the second physical asset comprising at least a second thermal mix-point (TMP);
(h) executing, by the computing device, a second computational fluid dynamics (CFD) analysis of at least one property of the at least the second TMP;
(i) generating, by the computing device, a second time series of a second output of the second CFD analysis;
(j) executing, by the computing device, for at least one time step in the generated second time series, a second structural analysis process of the second physical asset;
(k) executing, by the computing device, a second fatigue analysis of the at least one region of the second physical asset based on the second time series;
(l) generating, by the computing device, a second assessment of a level of fatigue of the at least one region of the second physical asset based upon an output of the second fatigue analysis; and
(m) displaying, by the computing device, the generated second assessment.

8. The method of claim 1 further comprising:
g) training, by the computing device, a machine learning engine, using at least one input to the CFD analysis, at least one output of the fatigue analysis, and the generated assessment.

9. The method of claim 8 further comprising:
(h) receiving, by the computing device, updated data from a sensor associated with the physical asset;
(i) repeating, by the machine learning engine, (b)-(e);
(j) generating, by the machine learning engine, an updated assessment of the level of fatigue of the at least one region; and
(k) modifying, by the computing device, a display of the generated updated assessment.

10. The method of claim 8 further comprising:
(h) receiving, by the computing device, data associated with an operating point associated with the physical asset;
(i) repeating, by the machine learning engine, (b)-(e);
(j) generating, by the machine learning engine, an updated assessment of the level of fatigue of the at least one region, based upon the data associated with the operating point; and
(k) modifying, by the computing device, a display of the generated updated assessment.

11. The method of claim 8 further comprising:
(h) constructing, by the computing device, at least a second model representing at least one region of a second physical asset, the second physical asset comprising at least a second thermal mix-point (TMP);
(i) executing, by the machine learning engine, a second computational fluid dynamics (CFD) analysis of at least one property of the at least the second TMP;
(j) generating, by the machine learning engine, a second time series of a second output of the second CFD analysis;
(k) executing, by the machine learning engine, for at least one time step in the generated second time series, a second structural analysis process of the second physical asset;
(l) executing, by the machine learning engine, a second fatigue analysis of the at least one region of the second physical asset based on the second time series;
(m) generating, by the machine learning engine, a second assessment of a level of fatigue of the at least one region of the second physical asset based upon an output of the second fatigue analysis; and
(n) displaying, by the computing device, the generated second assessment.
